(19) United States
(12) Patent Application Publication
(10) Pub. No.: US 2012/0159205 A1
(43) Pub. Date: Jun. 21, 2012

(54) START-UP CONTROL APPARATUS AND METHOD

(75) Inventor: LI-WEN GUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/193,621

(22) Filed: Jul. 29, 2011

(30) Foreign Application Priority Data
Dec. 20, 2010 (CN) 201010596690.3

(51) Int. Cl. G06F 1/26

(52) U.S. Cl. 713/310

(57) ABSTRACT

A start-up control apparatus includes a power supply, a control chip, and a sensing module. The control chip includes a switching on module and a control module. The sensing module senses a current of the power supply and send a safe message to the control module after determining the current of the power supply is less than a reference current. The control module receives the safe message and control the switching on module to switch on the power supply to power on a computer system after the switching on module receives a start-up trigger signal.

### BACKGROUND

1. Technical Field

The present disclosure relates to start-up control apparatuses and methods.

2. Description of Related Art

Usually, the power in a server does not disappear immediately after a power button is pressed to turn off the server because of the capacitors and inductances in the server. There is also a time delay between pressing the power button to turn on the server and the server actually being powered. Thus, it may waste time if a time delay is defined in the server.

### BRIEF DESCRIPTION OF THE DRAWINGS

FIG. 1 is a schematic view of a start-up control apparatus in accordance with an embodiment.

FIG. 2 is a flow chart of a start-up control method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

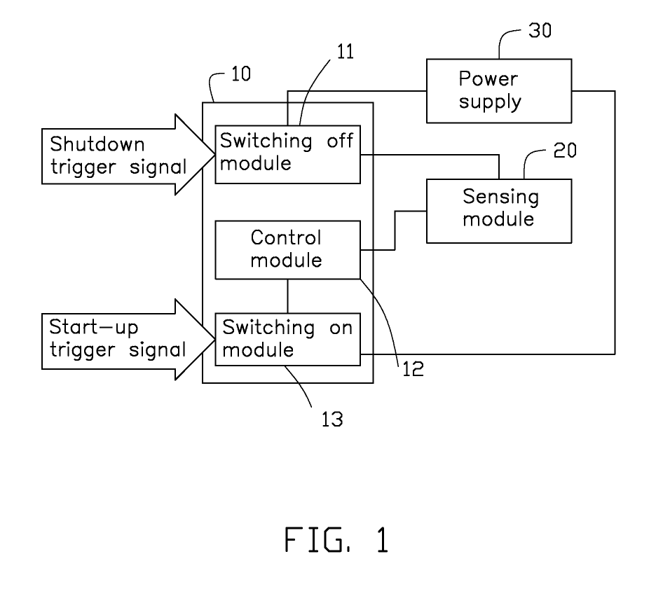

Referring to FIG. 1, a start-up control apparatus being applied in a computer system, includes a control chip 10, a sensing module 20, and a power supply 30. In one embodiment, the computer system is a server. In one embodiment, the sensing module 20 is a sensor and the control chip 10 is a programmable logic device.

The control chip 10 includes a switching on module 11, a control module 12, and a switching off module 13. The switching off module 11 is used for switching off the power supply 30 after receiving a shutdown trigger signal, and sending a shutdown notice about the shutdown trigger signal to the sensing module 20.

The sensing module 20 is used for sensing the current of the power supply 30 after receiving the shutdown notice, and sending a safe message to the control module 12 if the current of the power supply 30 is less than a reference current predetermined in the sensing module 20.

The control module 12 is used for receiving the safe message and controlling the switching on module 13 to switch on the power supply 30 after the switching on module 13 receives a start-up trigger signal. In one embodiment, the shutdown trigger signal and the start-up trigger signal are created by pressing a button of the computer system.

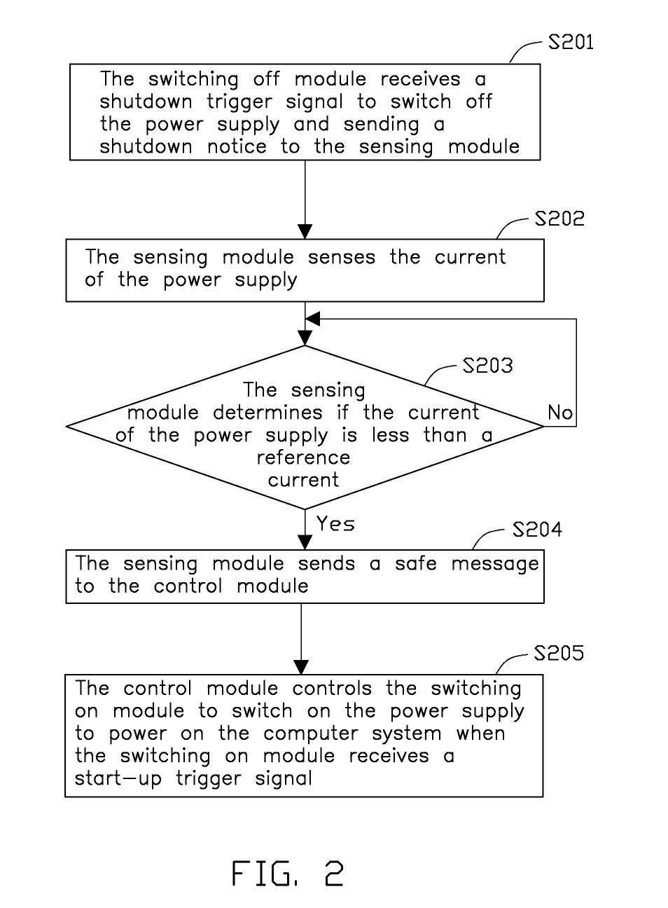

Referring to FIGS. 1 and 2, a start-up method is shown. An embodiment of the method is as follows.

In step S201, the switching off module 11 switches off the power supply 30 after receiving a shutdown trigger signal and sends a shutdown notice to the sensing module 20. During the process, the computer system is in a discharged state due to the shutdown of the power supply 30.

In step S202, the sensing module 20 senses the current of the power supply 30 after receiving the shutdown notice.

In step S203, the sensing module 20 determines if the current of the power supply 30 is less than a reference current. If so, the process continues to step S204. If not, the process continues to step S203.

In step S204, the sensing module 20 sends a safe message to the control module 12.

In step S205, the control module 12 controls the switching on module 13 to switch on the power supply 30 to power on the computer system when the switching on module 13 receives a start-up trigger signal.

In one embodiment, the control module 12 control the power supply 30 to power on or off the computer system by receiving signals from the sensing module 20.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A start-up control apparatus, comprising:
a power supply for powering a computer system;
a control chip, the control chip comprising a switching on module electrically in communication with the power supply and a control module electrically in communication with the switching on module; and
a sensing module electrically in communication with the power supply and the control module, the sensing module adapted to sense a current of the power supply and sending a safe message to the control module after determining the current of the power supply is less than a reference current;
wherein the control module is adapted to receive the safe message and control the switching on module to switch on the power supply to power on the computer system after the switching on module receives a start-up trigger signal.

2. The start-up control apparatus of claim 1, wherein the control chip further comprises a switching off module, the switching off module is electrically in communication with the sensing module and the power supply, the switching off module is adapted to receive a shutdown trigger signal to shut the power supply down and sending a shutdown notice about the shutdown trigger signal to the sensing module; and the sensing module is adapted to sensing the current of the power supply after receiving the notice.

3. The start-up control apparatus of claim 1, wherein the sensing module is a sensor.

4. The start-up control apparatus of claim 1, wherein the control chip is a programmable logic device.

5. A start-up control method, comprising:
sensing a current of a power supply by a sensing module;
sending a safe message to a control chip after determining the current of the power supply is less than a reference current; and
controlling a switching on module to switch on the power supply by the control chip when the control chip receives the safe message and the switching on module receives a start-up trigger signal.

6. The start-up control method of claim 5, wherein the sensing module is a sensor.

7. The start-up control method of claim 5, wherein the control chip is a programmable logic device.
